(19) United States
(12) Patent Application Publication
(10) Pub. No.: US 2020/0347979 A1
(43) Pub. Date: Nov. 5, 2020

(54) Novel Pipe-Repair Tool

(71) Applicant: Williams Natural Resources, LLC, Weatherford, TX (US)

(72) Inventor: Jason Williams, Weatherford, TX (US)

(73) Assignee: Williams Natural Resources, LLC, Weatherford, TX (US)

(21) Appl. No.: 16/860,256

(22) Filed: Apr. 28, 2020

Related U.S. Application Data
(60) Provisional application No. 62/843,038, filed on May 3, 2019.

(51) Int. Cl. F16L 55/1645; F16L 55/18; B05B 13/06; B05D 7/22

(52) U.S. Cl. CPC F16L 55/1645; F16L 55/18; F16L 2101/18; B05D 7/222; B05B 13/0627

(57) ABSTRACT

A pipe-repair tool is disclosed. The pipe-repair tool includes a first chamber to hold a first pressurized sealant and a valve to selectively allow the sealant to flow from the chamber into the interior of a pipe to be repaired. The tool may include a second chamber to hold a second pressurized sealant when using a two-part sealant, in which case the first sealant and the second sealant flow through a mixing chamber when flowing from the first and second chambers to the interior of the pipe. The valve may be a mechanical valve that is opened by moving the tool relative to the pipe to be repaired. The valve may be an electrically controlled valve that is opened with an electrical signal.

### CROSS-REFERENCE TO RELATED APPLICATIONS

This application claims the benefit of U.S. Provisional Application No. 62/843,038, filed on May 3, 2019.

### BACKGROUND

This invention pertains generally to technology for repairing tubular members (pipes) such as tubing or casing that may be used in an oil or gas well. More specifically, the invention pertains to an internally deployable pipe-repair tool.

Pipes are used in many industries to transport fluids, gases, and solids. In some cases, repairing leaks that occur in the pipe can difficult or impossible due to the location of the pipe or the environment in which it is located. For example a casing leak in an oil well cannot typically be repaired by removing the pipe because it is cemented into place. Most such leaks are repaired by squeezing a cement-based solution into the hole or covering it with an internal liner. Both solutions can be expensive and somewhat complex, liners can also limit the internal diameter of the pipe causing a loss of flow and limiting the type and size of tool that can installed in the well. In another example, most leaks in production tubing can only be fixed by removing the pipe with a rig, repairing or replacing the defect and then reinstalling the pipe. This process can also be somewhat expensive, complex, and dangerous. Installing liners into a pipe to facilitate a repair can limit the internal diameter of the pipe, and in both examples, the well can unexpectedly release oil, gas, or other contaminates that could cause harm to workers or the environment. Other industries face similar challenges to repairing leaks in hazardous and hard to access locations.

Accordingly, there is a need for technology for efficient in-situ repair of damaged pipes.

### SUMMARY

A pipe-repair tool according to an aspect of the invention includes a pressurized accumulator for holding and dispersing a sealant within a tubular member. In one exemplary embodiment, the tool includes a single accumulator for a single-part sealant. In a second exemplary embodiment, the tool includes two accumulators for a two-part sealant comprising two parts that are to be mixed together for the sealing application. In this embodiment, one accumulator holds one part of the two-part sealant (“Part A”) the other accumulator holds the second part of the two-part sealant (“Part B”). In principle, multi-component sealants may be held and dispersed by a tool comprising an accumulator for each component of the sealant. A single tool may also include more than a single accumulator for each sealant component. For example, a two-accumulator tool may be used with a single-component sealant with each accumulator filled with the same sealant.

The tool also includes a sealant-deployment valve having a discharge port. The discharge end of the accumulator is connected to the deployment valve, perhaps through a mixing chamber. For example, in a single-accumulator single-part-sealant embodiment, the discharge end of the accumulator is attached to the valve such that when the valve is opened the sealant flows from the pressurized accumulator through the valve out of the discharge port. Similarly, in a two-accumulator two-part-sealant embodiment, the discharge end of each accumulator is connected to a mixing chamber and then to the valve such that when the valve is opened, the Part A sealant component flows from one accumulator into the mixing chamber, the Part B sealant component flows from the other accumulator into the mixing chamber, that Part A and Part B sealant components mix together in the mixing chamber, and the mixed sealant flows from the mixing chamber through the valve out of the discharge port.

The tool may include two sealant-retaining rings on the outside of the tool, one positioned above the sealant-deployment valve's discharge port and the other below the discharge port. These two deployment-valve rings are configured to hold a pressurized zone of sealant in the annulus between the tool and the inside surface of the pipe when the valve is opened. When the sealant-deployment valve is opened, the pressurized sealant is forced out of the accumulator(s), into the mixing chamber (if present), exits the tool at the discharge port, and enters the bore of the pipe. The sealant is kept under pressure due to the sealant rings above and below the valve opening. As the tool is moved to the hole in the pipe, the pressurized sealant between the sealant rings is forced into the hole, sealing it.

The tool may include a bypass tube going through the tool which allows the tool to be deployed in tubing that contains fluid. The tool may include a fishing neck located on the top of the tool to be used in the event the tool becomes stuck in the tubing.

The sealant-deployment valve may be mechanically controlled. In an embodiment of a mechanically-controlled valve, the tool includes tensioned pivot arms (also known as fingers), and a sleeved sliding deployment-valve. Each pivot arm includes a dog at one end and is pivotally connected to the sleeve of the sliding deployment-valve at the other end. In one deployment-valve sleeve position (the “closed” position), the sliding deployment-valve sleeve plugs the discharge port to prevent egress of sealant through the port. In another sleeve position (the “open” position), the sliding deployment-valve sleeve exposes the discharge port to allow sealant to egress through the port. The pivot-arm dogs are configured to engage a pipe collar as the tool is pulled back through the pipe, and to thereby pull the sleeve from the closed position to the open position.

In operation of this embodiment, the pivot arms are tensioned out with a tensioner (e.g., a spring or retaining ring) when in the valve-closed position, allowing the pivot-arm dogs to contact the wall of the pipe when deployed into a pipe. The pivot-arm dogs are positioned to allow the pipe repair tool to proceed into the pipe in a centralized manner (e.g., when descending through a cased wellbore), preventing the pivot-arms from contacting the edge of the pipe when entering the collar void of the pipe connection. The tool is deployed into the pipe at least one collar past the portion to be sealed while the pivot-arms are tensioned in the “out” position. During deployment into the pipe, the tensioned pivot-arms prevent the sliding deployment-valve from opening prematurely, and thereby prevent premature (unwanted) discharge of sealant.

Once the tool has been deployed to the appropriate position (at least one collar past the damaged portion of the pipe), the tool is moved in the opposite direction (e.g., ascending through a cased wellbore). On encountering a collar, the pivot-arm dogs engage the collar void and pull on the pivot arms as the tool continues to move. This causes the deployment-valve sleeve to move to the open position, exposing the discharge port and thereby releasing sealant to flow from the accumulator to seal holes in the pipe. Simultaneously, the pivot-arm-dog engagement with the collar moves the pivot arms away from the tensioner to allow the pivot arms to pivot to a position closer to the tool body. This allows the pivot-arm dogs to disengage the collar void and prevents the pivot-arm dogs from engaging other collar voids as the tool is moved back through the pipe (which in turn helps keep the tool from sticking in the pipe or damaging collars). To help prevent sticking, a pivot arm may be connected to the tool through a sheer pin which will sheer if the pivot-arm dog does not release the collar, thus releasing the pivot arm from the tool or allowing it to reposition such as to disengage the collar. Similarly, the pivot-arm dog may be joined with the pivot arm through a sheer pin which will sheer if the pivot-arm dog does not release the collar, thus releasing the pivot-arm dog from the tool or allowing it to reposition such as to disengage the collar.

In another embodiment, the sealant-deployment valve may be electrically controlled. In an embodiment of the electrically-controlled valve, the tool includes an electric motor to move the sliding sleeve through application of an electrical signal (e.g., a voltage or current) when the tool is in the desired position. In another embodiment, the deployment valve may employ a means other than a sliding sleeve to plug/unplug the discharge port. For example, a diaphragm or piston may be used to plug the discharge port in a relaxed position and may be electrically positioned to unplug the port on application of an electrical signal. The electrical signal may be provided through a power source external to the tool. For example, a control unit connected to the tool through electric wireline can be controlled to provide the signal. The electrical signal may be provided through a power source internal to the tool. For example, the tool may include a battery that is selectively connected to the valve through mechanical means, such as through pivot-arms similar to those described above, but that instead activate a switch rather than move a sliding sleeve. In another example, the battery may be connected to the valve by controlling a switch through application of a pressure to fluid in the pipe.

In another embodiment, the sealant-deployment valve may be pressure controlled. For example, selective application of pressure to fluid within the pipe may be used to position the sliding deployment-valve sleeve (or to position a diaphragm or piston) to unplug the discharge port.

### BRIEF DESCRIPTION OF THE DRAWINGS

These and other features, aspects, and advantages of the present invention will become better understood with reference to the following description, appended claims, and accompanying drawings where:

FIG. 1 is a schematic view illustrating an exemplary mechanically-operated internally deployable pipe-repair tool deployed within damaged casing set in an oil well.

FIGS. 2A-2B are schematic views illustrating an exemplary mechanically operated internally deployable pipe-repair tool in the opened and closed positions according to an aspect of the invention.

FIGS. 3A-3B are schematic views illustrating an exemplary electrically operated internally deployable pipe-repair tool in the opened and closed position according to an aspect of the invention.

FIGS. 4A-4B are schematic views illustrating an exemplary mechanically operated internally deployable pipe-repair tool in the opened and closed positions according to an aspect of the invention.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

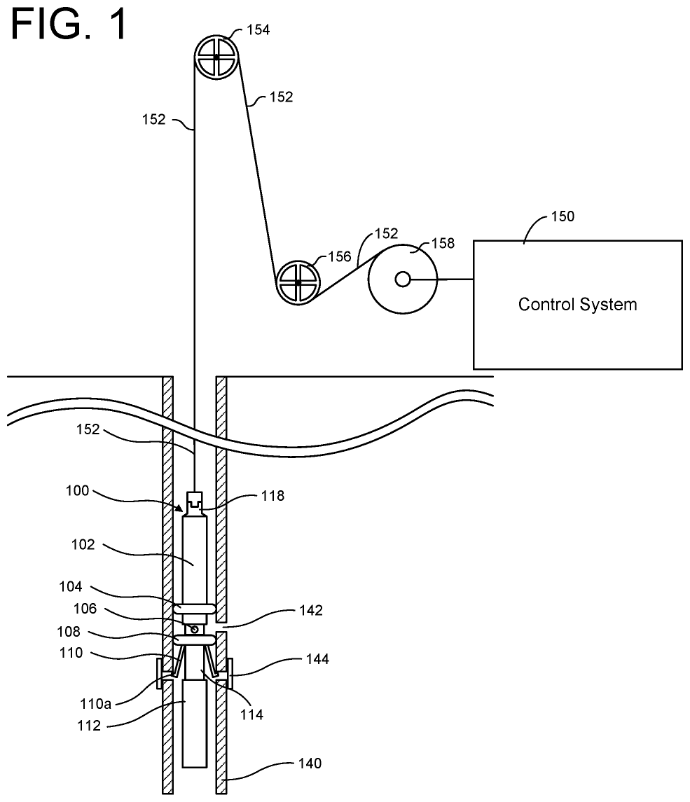

FIG. 1 depicts an exemplary mechanically-controlled pipe-repair tool 100 deployed in pipe 140. In this illustration, the tool 100 is deployed at the end of wireline 152 or slickline in a cased oil well in order to effect repairs to casing 140 in the well. The tool 100 is positioned in the casing 140 through operation of a winch 158 to spool the wireline 152 that is positioned through use of sheaves 154, 156. The wireline 152 may be spooled out (moving the tool 100 down in the figure) or in (moving the tool 100 up in the figure) through the control system 150. The deployment of the tool is certainly not limited to such a configuration and the tool may be positioned in any appropriate fashion, such as by lowering, pushing, pulling, or pumping the tool into position.

The tool 100 includes a first accumulator chamber 102 and a second accumulator chamber 112. Each accumulator chamber 102, 112 is configured to hold a pressurized sealant component and is connected to a mixing chamber 114 and from there to a discharge port 106. (A single discharge port 106 is depicted, but the tool may include multiple discharge ports.) Each accumulator chamber 102, 112 may be loaded with a pressurized sealant component that loads a spring (not shown) to maintain the pressure. The chambers 102, 112 may include an equalization port so that when deployed in a pressurized setting (e.g., down an oil well), the ambient pressure will be added to the spring force so that the sealant component is maintained at a pressure above the ambient pressure. The tool 100 further includes a first sealant-retaining ring 104 and a second sealant-retaining ring 108. The retaining rings 104, 108 will typically include an elastomeric material at the outside surface. In this embodiment, the second sealant-retaining ring 108 is also configured as a sliding deployment-valve sleeve. (In other embodiments, the second sealant-retaining ring may be a component separate from the deployment-valve sleeve. In other words, while this embodiment includes both a second sealant-retaining ring and a sliding deployment-valve sleeve, this ring and sleeve may be a single component or multiple components.) The tool further includes pivot arms 110 pivotally attached to the second sealant-retaining ring/sliding sleeve 108. One end (the “proximal” end) of each of the pivot arms 110 is pivotally attached to the second sealant-retaining ring/sliding sleeve 108. The other end (the “distal” end) of each of the pivot arms 110 is configured to engage a feature of the interior surface of the pipe 140. For example, the distal ends of the pivot arms 110 may be configured with a dog 110a to engage a groove or void at a pipe collar 144, the point at which two pipe segments are joined together. (The groove or void may be the space between the mated pipe joints.)

In operation, when the distal ends of the pivot arms 110 engage the feature of the interior surface of the pipe 140 while the tool is moved through the pipe 140, the pivot arms 110 pull the second sealant-retaining ring/sliding sleeve 108 away (down in the figure) from a position over the discharge port 106. This unplugs (opens) the discharge port 106 and creates flow paths for the pressurized sealant components in the first and second accumulator chambers 102, 112. The sealant then flows into the mixing chamber 114 and from there out of the discharge port 106. The first and second retaining rings 104, 108 engage the inner surface of the pipe 140 so as to substantially retain the discharged sealant in position relative to the tool 100 such that the discharged sealant substantially moves with the tool 100 while the tool moves through an undamaged section of the pipe 140. Once the tool 100 is positioned in the pipe 140 such that the section between the first and second retaining rings 104, 108 overlaps with a damaged section of the pipe 140, the pressurized sealant will flow into the hole 142 in the pipe 140, to seal the hole 142 and repair the pipe 140. The tool 100 is depicted in FIG. 1 as the pivot arms 110 engage the pipe 140 to open the valve in position next to a hole 142 in the pipe 140.

As depicted, exemplary tool 100 may include a head 118 by which the tool is connected to the wireline 100. The head 118 may include a feature (e.g., a fishing neck) by which the tool 100 may be retrieved if it becomes disconnected from the wireline 152 or slickline during operation.

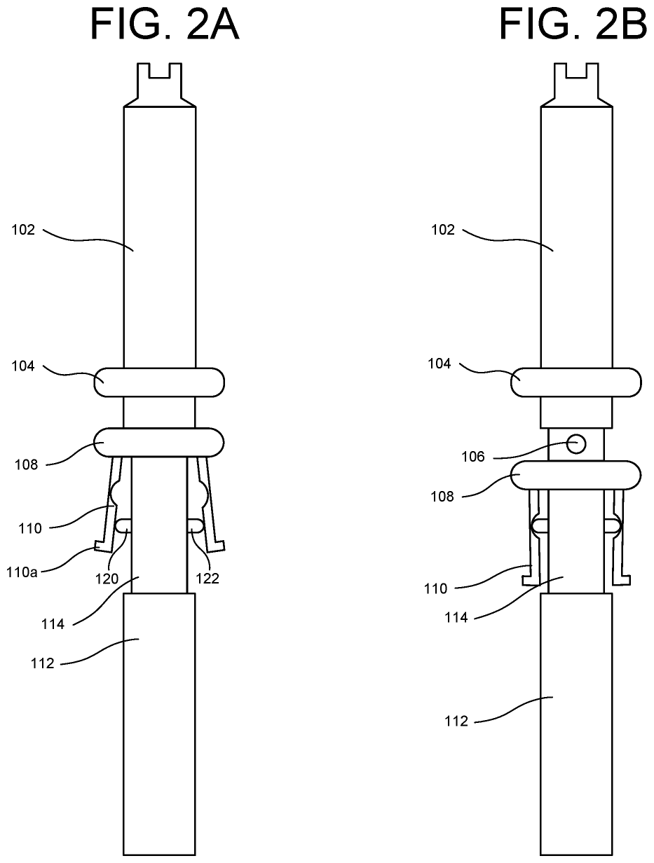

FIGS. 2A and 2B depict the exemplary pipe-repair tool 100 in closed and open positions respectively. In the closed position (shown in FIG. 2A), the second sealant-retaining ring/sliding sleeve 108 is positioned over the discharge port 106. The pivot arms 110 are tensioned out from body of the tool 100 by tensioners 120, 122 (such as springs). (Tensioners 120, 122 are shown for each pivot arm 110 in the figure, but a single tensioner such as a retaining ring may be used for multiple pivot arms.) The pivot-arm dogs 110a may be, for example, flexible components each pivotally connected at one end to a pivot arm 100 and configured at the other end to engage a feature of the inner surface of the pipe in which the tool is deployed. In operation, the pivot arms 110 and pivot-arm dogs 110a help centralize the tool when the tool 100 is deployed into the pipe (moved down in the figure).

When in the closed position, the tool 100 can be deployed to the damaged portion of the pipe 142. Once appropriately positioned in the pipe 140, the tool 100 will be moved in the opposite direction (moved up in the figure), the pivot-arm dogs 110a will engage the void of a collar, pulling the pivot arm 110 and thus the sealant-retaining ring/sliding sleeve 108 away (down in the figure) from the discharge port 106 to place the tool in open position. As the tool 100 transitions into the open position, the pivot arms 110 will move relative to the tensioners 120, 122 such that the pivot arms 110 may pivot in to the tool and disengage the pipe 140.

(The pivot arms 110 depicted in FIGS. 2A and 2B are shown with features to accept the tensioners and allow the pivot arms to pivot in to the tool when the tool is in the fully opened position. In other embodiments, the pivot arms may be narrower at the pivot point than at the dog end, which would similarly allow the pivot arms to pivot in when the tool is in the fully opened position. In other embodiments, the tensioners or the pivot arms may be screw-mounted to the tool such that they rotate relative to each other as the pivot arms and sleeve slide along the tool, which would place the tensioners in the gaps between pivot arms which in turn would allow the pivot arms to pivot in when the tool is in the fully opened position.)

As described above, the pressurized sealant will be retained by the top and bottom retaining rings 104, 108 when the sealant-retaining ring/sliding sleeve 108 is in the open position (as shown in FIG. 2B). This creates a pressurized zone of sealant that will move with the tool 100 until the tool 100 moves into a position over the hole 142 in the pipe 140. When the pressurized zone of sealant comes in contact with the hole 142, the sealant will be forced into the hole 142 to seal the hole 142. The second sealant-retaining ring 108 will wipe the inside of the pipe 140 as the tool 100 continues to move, leaving the internal diameter of the pipe 140 substantially unchanged yet sealing the hole 142.

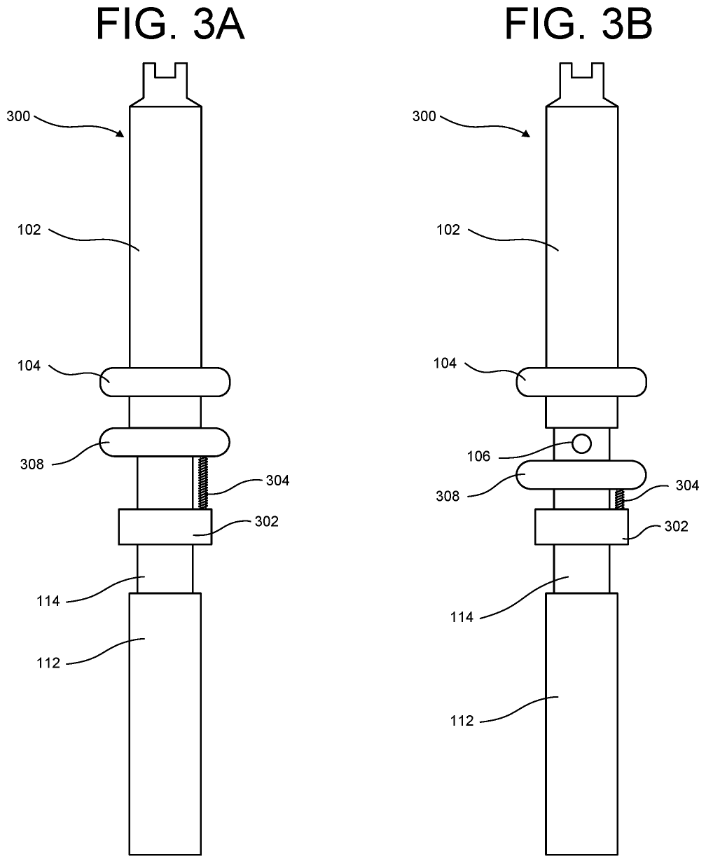

FIGS. 3A and 3B depict another exemplary pipe-repair tool 300 in closed and open positions respectively. The tool 300 is electrically controlled and is similar to the mechanically-controlled tool 100 described above with referenced to FIGS. 1, 2A, and 2B. The components that are the same in the two embodiments are labeled the same. The difference between the two embodiments is in the structure to open the discharge port 106. The electrically-controlled tool 300 includes a second sealant-retaining ring/sliding sleeve 308 that is mechanically connected to an electric actuator 302 through a positioning rod 304. For example, the rod 304 may be threaded and the electric actuator 302 may include an electric motor that drives the rod 304 into the ring 308 or into the actuator 302 to bring the ring 308 closer to the actuator 302. In another embodiment, the rod 304 may be magnetically positioned by the actuator 302. With the electrically-controlled tool 300, a wire (not shown) may attach the tool to an electrical source outside the tool, where the tool operator can selectively apply the appropriate signal to open the valve and release the sealant. In this embodiment, the tool 300 does not necessarily use a feature of the internal surface of the pipe to open the discharge port 106.

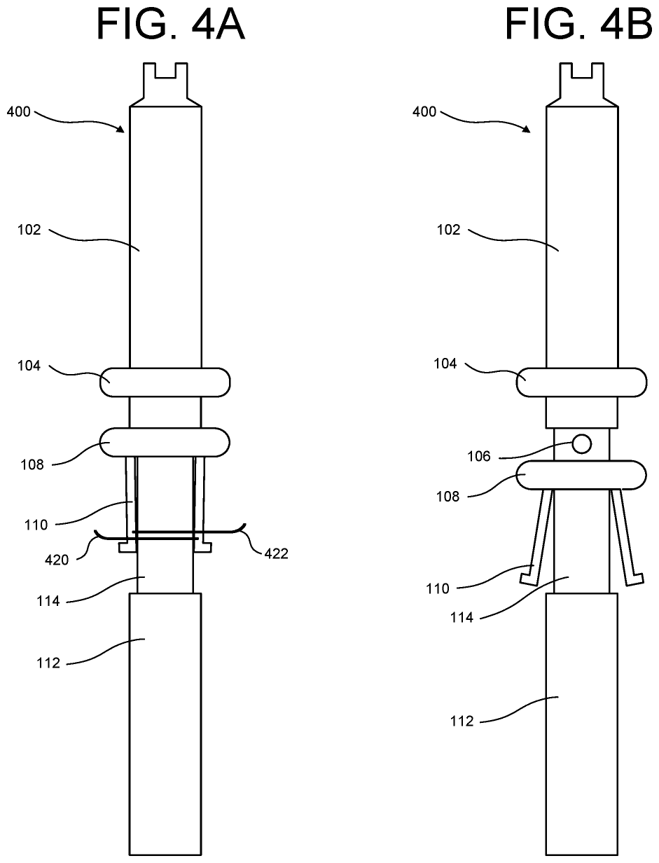

FIGS. 4A and 4B depict another exemplary pipe-repair tool 400 in closed and open positions respectively. The tool 400 is mechanically controlled and is similar to the mechanically-controlled tool 100 described above with referenced to FIGS. 1, 2A, and 2B. The components that are the same in the two embodiments are labeled the same. The difference between the two embodiments is in the structure to open the discharge port 106. The pivot arms 110 are held in against the body of the tool 400 by collar triggers 420, 422 (resisting the tension configured to pivot the pivot arms 110 out from the tool). The collar triggers 420, 422 may be, for example, latches with flexible extensions. Each latch is pivotally connected to a pivot arm 110 and configured to latch the pivot arm to the tool. The latch extension is configured to engage a collar. In operation, the latch extensions flex and maintain the latch when the tool deployed into the pipe (down in the figures) and the latch extensions engage a collar causing the latch to pivot and release the latch when the tool is brought back through the pipe (up in the figures). (In other embodiments, a single collar trigger is configured to latch/release multiple pivot arms.)

Numerous types of valves in addition to those described above may be used to achieve the release of sealant. For example, a customary solenoid valve or latching valve may be placed between the mixing chamber and discharge port and used in conjunction with two fixed retaining rings (i.e., neither slide along the tool). The discharge port could thus be selectively closed/opened without a discharge-port-covering sleeve. In addition to valves, electronically controlled explosive and chemical triggers can also be used to open the discharge port to release the sealant from the tool.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A pipe-repair tool comprising:
(a) a generally-tubular first accumulator chamber configured to hold pressurized sealant, the first accumulator having a longitudinal axis;
(b) a sealant-deployment valve connected to the accumulator chamber and having a discharge port; and
(c) a means for opening the sealant-deployment valve and thereby enabling pressurized sealant in the first accumulator chamber to flow out the discharge port.

2. The pipe-repair tool of claim 1 further comprising:
(a) a generally-tubular second accumulator chamber configured to hold pressurized sealant;
(b) a mixing chamber connected to the first accumulator chamber and the second accumulator chamber;
(c) wherein the seal-deployment valve is connected to the first accumulator chamber and the second accumulator chamber through the mixing chamber.

3. The pipe-repair tool of claim 2 further comprising:
(a) a first-part sealant of a two-part sealant, the first-part sealant disposed in the first accumulator chamber; and
(b) a second-part sealant of the two-part sealant, the second-part sealant disposed in the second accumulator chamber.

4. The pipe-repair tool of claim 1 further comprising a bypass tube running generally parallel to the first accumulator chamber's longitudinal axis and bypassing the first accumulator chamber and the sealant-deployment valve.

5. The pipe-repair tool of claim 1 further comprising:
(a) a first retaining ring at a first position along the first accumulator chamber's longitudinal axis; and
(b) a second retaining ring at a second position along the first accumulator chamber's longitudinal axis;
(c) wherein the discharge port is positioned along the first accumulator chamber's longitudinal axis at a point between the first retaining ring and the second retaining ring.

6. A method of repairing a pipe comprising:
(a) disposing in a pipe a generally-tubular first accumulator chamber containing a pressurized sealant, wherein the pipe has a longitudinal axis and the first accumulator chamber has a retaining ring disposed about it;
(b) opening a valve to allow at least a portion of the pressurized sealant to flow from the first accumulator chamber into the interior of the pipe; and
(c) moving the first accumulator chamber along the pipe's longitudinal axis and thereby causing the retaining ring to move at least a portion of the pressurized sealant allowed to flow into the interior of the pipe.

7. The method of claim 6 wherein the step of opening a valve is performed by moving the first accumulator chamber along the pipe's longitudinal axis.

8. The method of claim 6 wherein the step of opening a valve is performed by sending an electric signal to the valve.

9. A pipe-repair tool comprising:
(a) a tool body having a longitudinal axis;
(b) a first accumulator chamber disposed in the tool body;
(c) a discharge port disposed in the tool body at a first longitudinal position along the longitudinal axis and connected to the first accumulator;
(d) a selectively movable sleeve configured to cover the discharge port in a first sleeve position and to uncover the discharge port in a second sleeve position;
(e) a first packing component positioned along the tool body at a second longitudinal position along the longitudinal axis; and
(f) a second packing component positioned along the tool body at a third longitudinal position along the longitudinal axis;
(g) wherein the first longitudinal position is between the second and third longitudinal positions; and
(h) wherein the first and second packing components are configured to fill an annulus between the tool body and an inner surface of a pipe when the tool is deployed within the pipe.

10. The pipe-repair tool of claim 9 further comprising:
(a) a pivot arm having a first end and a second end;
(b) wherein the pivot arm is pivotally attached to the selectively movable sleeve at the pivot arm's first end; and
(c) wherein the second end of the pivot arm includes a dog configured to engage a pipe coupling.

11. The pipe-repair tool of claim 9 further comprising:
(a) an electric actuator from the group consisting of an electric motor and an electromagnetic actuator; and
(b) a positioning rod connecting the electric actuator to the selectively movable sleeve;
(c) wherein the electric actuator is operable to move the positioning rod and thereby move the selectively movable sleeve from the first sleeve position to the second sleeve position.
